(19) United States
(12) Patent Application Publication
(10) Pub. No.: US 2008/0015741 A1
(43) Pub. Date: Jan. 17, 2008

(54) Valve cluster and a communication method therefor

(75) Inventor: Hrvoje Vuksanovic, Denkendorf (DE)

Correspondence Address: HOFFMANN & BARON, LLP, 6900 JERICHO TURNPIKE, SYOSSET, NY, 11791, US

(73) Assignee: FESTO AG & CO.

(21) Appl. No.: 11/732,163

(22) Filed: Apr. 3, 2007

(30) Foreign Application Priority Data
Apr. 19, 2006 (DE) 10 2006 018 220.0

(51) Int. Cl. G05D 7/00; G05D 11/00

(52) U.S. Cl. 700/282

(57) ABSTRACT

A valve cluster and a communication method operate with valves. arranged in a row direction against each other and with a control means for the control and/or monitoring of the at least one internal component included in the valve cluster or at least one external component connected with the valve cluster, more particularly a valve, the control means comprising a Web server for providing monitoring data relative to the at least one component for a monitoring means at the communication interface. The monitoring means requests monitoring data from the Web server, whereupon the Web server transmits a page data set for a monitoring page able to be displayed by a browser of the monitoring means in a markup language. The monitoring means executes the request program code included in the at least one page data set and sends at least one message for requesting reload data, which the Web server transmits to the monitoring means in a manner dependent on a structure and/or a status of the valve cluster and/or of the at least one component by way of the communication interface so that the monitoring means may generate and/or update the monitoring page by the execution of generation program code contained in the page data set or the reload data.

The invention relates to a valve cluster including fluid power valves arranged in a row direction against one another and a control means for the control and/or monitoring of at least one internal component comprised in the valve cluster or at least one external component connected with the valve cluster, in particular a valve, the control means comprising a Web server for the provision of monitoring data relevant to the at least one component for a monitoring means at a communication interface, and to a communication method for such a valve cluster.

Such a valve cluster is for example described in the European patent publication EP 1 272 767 B1. However it is elaborate in its realization with a microcomputer as is normally employed in a valve cluster, to produce a dynamic representation of the valve cluster dependent on, for example, its structure, its operational states and the like. In the case of “large” Web servers, which are for example utilized in the case of online shops dynamic generation of Internet pages is known, for example in a manner dependent on the requests of a user of the online shop, for example using a PHP (hypertext preprocessor). The computer power necessary is however frequently not available in the case of a microcomputer of a valve cluster.

On the other hand it would be conceivable to load a Website, representing the respective configuration, in valve cluster. However for this purpose it is necessary, for each individual valve cluster, to generate a Web page and to load it into the valve cluster. Updating of the Website, for example for the display of current operational states is impossible or in any case at least extremely difficult.

Accordingly one aim of the present invention is to provide for dynamic generation and/or updating of a monitoring page for a valve cluster of the type initially mentioned, in the case of which the monitoring page is to be able to be represented by a browser of a monitoring means.

In order to this aim for the valve cluster there is a provision such that the monitoring data, which are provided by the Web server to the monitoring means on request, comprise at least one page data set for a monitoring page able to be represented by a browser in a markup language and/or in a page description language, the at least one page data set contains request program code on whose execution by means of a processor the monitoring means transmits, for the generation of the monitoring page, at least one message for the request of reload data to the Web server, the control means is adapted to transmit the reload data on the basis of stored data modules in a manner dependent on a structure and/or a status of the valve cluster and/or the at least one component by way of the communication interface, and the at least one page data set or the reload data comprise generation program code on whose execution by means of the processor the monitoring means dynamically generates and/or updates the monitoring page on the basis of the reload data. Furthermore for attaining the aim of the invention a communication method is provided for a valve cluster in accordance with the technical principle of a further claim.

A basic principle of the invention is furthermore to relocate processor power necessary for generating or, respectively, updating the at least one monitoring page in the monitoring means, for example by way of a personal computer connected by way of the Internet with the valve cluster. Here the necessary computer power is available. The valve cluster or, respectively, its processor, which executes the program code of the Web server, is relatively only slightly loaded by updating and generation of the monitoring page. The term “monitoring page” employed in the invention also comprises diagnostic pages, server pages or the like. Furthermore there is the advantage of being able to execute control instructions for example, indicated by the monitoring means at the control means of the valve cluster. A sensor within the meaning of the invention may also be a switch, which produces a message or, respectively, a switching signal. The request program code or the generation program code are for example embedded in the page data set or the reload data. It would be conceivable for the request program code and the generation program code to constitute a single program module. Furthermore it is possible for the generation program code to be in two parts, one module being responsible for the generation of the at least one monitoring page and an updating module performing the update of the monitoring page. The input and/or output interface for the at least one component, for example valve, external or internal actuators or sensors, preferably comprises an internal bus and/or a field bus of the valve cluster. Moreover an input and/or output interface is preferably a bidirectional interface in order to not only be able to receive message from sensors but also to transmit instructions and/or parameters to sensors. By way of a bidirectional interface it is possible for the control means to also receive messages from actuators, for example for display on the monitoring page.

The control means is preferably designed for local control and/or monitoring of the valve cluster.

The valve cluster is preferably a pneumatic valve cluster. In the case of the actuators it is preferably a question of pneumatic piston rod cylinders or rodless linear drives, which are able to be controlled with the valves of the valve cluster pneumatically. Other linear or rotary drives, as for example electrical or electropneumatic hybrid drives are able to be controlled and/or monitored with the valve cluster in an advantageous manner.

In accordance with the invention it is possible to dynamically generate a Web site for monitoring and/or diagnosis and/or servicing of the valve cluster. In this case the at least one page data set constitutes a component of a Website, which at least at least partially represents the valve cluster. Furthermore it is possible to represent actuators, which are individually connected with the valve cluster, and/or sensors on the Website, as for instance different types of pneumatic cylinders, different types of sensors, for example distance sensors, optical sensors or the like. By executing the request program code and/or the generation program code, in the case of which it is a question for example of JAVA scripts and/or JAVA applets, the monitoring means generates dynamically and interactively with the control means of the valve cluster the page of the Website and/or updates the pages of the Website.

It is basically possible for a suitably powerful control means of the valve cluster to generate the Website already on pages of the valve cluster, at least partially dynamically. In this case as well it is convenient for the updating of a respective monitoring page to be triggered by the execution of the request program code and/or generation program code by the monitoring means. A spontaneous transmission of monitoring data, for example when the operational status of the valve cluster has changed, is normally only possible, when the monitoring means sends a correspond request to the valve cluster. In this case the generation program code, and more particularly an updating function comprised therein, is best put into operation and serves to provide an updated display of the valve cluster or, respectively, a component, comprised in the valve cluster or connected with same.

Preferably the generation program code and/or the request program code are designed for cyclical updating of the monitoring page so that for example every minute, in a one-seconds cycle or in a longer cycle the monitoring means sends a request to the valve cluster or, respectively, its Web server for generating and/or updating the respectively displayed monitoring page.

By execution of the request program code or, respectively, the generation program code the monitoring means dynamically builds the monitoring page, in particular a Website concerning the valve cluster. For instance the at least one page data set may comprise a basic structure of the monitoring page, which on execution the generation program code is filled on the basis of the reload data with contents. The page data set comprises data necessary for the representation of the monitoring page in a markup language, in particular in a descriptive markup language, for example the languages defined in standard generalized markup language (SGML) or extensible markup language (XML) as hypertext markup language (HTML), W(ireless)ML, extensible application markup language (XAML) or scalable vector graphics (SVG). A markup language is also termed a page descriptive language.

The page data set preferably comprises a skeleton of the monitoring page. For instance the basic structure may comprise at least one empty table with at least one table line. Preferably several pages are present, which, during execution of the generation program code, are supplemented bit by bit with subtables, further lines, graphics, templates (e.g. HTML or XML templates) and the like. A template will for example comprise several HTML lines.

The generation program code will preferably prevent a display or updating of the monitoring page until all reload data, necessary for the representation of the monitoring page, are provided by the Web server. However a sequential updating of the monitoring page is possible as well.

Preferably data for the at least one page data set and the reload data may be loaded into the control means, for example by way of the communication interface. The data constitute a library as it were, from which the control means of the valve cluster serves the monitoring means, when the monitoring means, during execution of the request program code, sends corresponding requests for the generation of the respective monitoring page to the control means. Furthermore the data preferably comprise one or more basic structures for the monitoring pages. Accordingly it is for example possible to load a data base into the control means of the valve cluster, sends a request to the control means in a manner dependent on the respective structure and/or status of the valve cluster or of components connected therewith in order to offer the at least one page data set and/or the reload data. Accordingly it is for example possible to load new graphics in the control means, which render possible a different type of representation or an improved representation of a respective valve cluster. Furthermore it is conceivable, when new valves are developed, to load the one new data base (with a graphic representation of such valves or further details for an already existing data base) into the valve cluster or its control means.

For instance the data modules may comprises graphical representations of at least one component included in the valve cluster or connected with the valve cluster, as for instance valves, actuators, sensors or the control means itself. The control means selects the graphical representations in a fashion dependent on a respective operational state of the component, for instance of a valve, actuator or sensor. Thus f. i. normal conations may appear in green or faulty conditions in red or the like. Moreover it is possible, in this manner, to flash in graphical warning signals in trouble conditions or the like.

A convenient modification of the invention is such that the graphic representations for example comprise a graphical events table of a respective operational or failure status for a predetermined or preset time. The time, in which the operational status is traced, is preferably able to be configured, more particularly by way of the Web server. It is an advantage for the Web server to be designed to transmit the graphical representations as segments of an overall representation. On execution of the generation program code the monitoring means will, by combination of the graphical segments, produce an overall representation. The segments are for example individual valves of the valve cluster or components. Furthermore it would be conceivable for the valves or components to be segmentally represented so that for example a bottom portion of valve remains unchanged, whereas a top portion of the valve, on which status displays with different colors are provided, is dynamically transmitted in a manner dependent on the respective status of the valve from the Web server to the monitoring means.

It is an advantage for the generation program code and/or the request program code to generate an updated display on the monitoring page, which indicates an active communication between the monitoring means and the control means for the operator of the monitoring means. For instance a text, more particularly animated graphics, a green running light symbol or the like, is displayed by the generation program code and/or the monitoring program code on the monitoring page or for producing trouble-free communication graphics are exchanged for a moving sequence. Furthermore the exchange of a graphic for indicating trouble-free communication (for instance in green) by a graphic for a graphic for indicating imperfect communication, for example in red, is conceivable.

As already mentioned the request program code and the generation program code can be constituted by separate program parts or a single program. It is convenient if, for example, the request program code or a communication program code are constituted by a JAVA applet. A JAVA applet is executed by a so-called virtual machine of the monitoring means. A JAVA script, which is advantageous for dynamically generating the monitoring page, is executed by a browser of the monitoring means. It is particularly preferred for the request program code to hold ready a user datagram protocol (UDP) interface and/or a hypertext transfer protocol (HTTP) interface, more particularly in a fashion dependent on the respective availability of the interface. It is an advantage the request program code necessary for this interface to be transmitted once by the Web server to the monitoring means and utilized by the monitoring means for request of further monitoring pages.

As part of the display of the Website it is advantageous for the first page data set and/or the reload to include data for the generation of a navigation element able to be displayed by the browser of the monitoring means, for instance a link, a button or the like. On activation of the navigation element the request program code and/or generation program code produce a message for the request of a second monitoring page to the Web server, which transmits with a page data set with a second program request code or generation program code able to be executed by the processor of the monitoring means. With the aid of this further program code the monitoring means dynamically generates the second monitoring page or further monitoring pages. These monitoring pages relate, for example, to individual components of the valve cluster. whereas the first monitoring page displays the valve cluster as a whole at least symbolically.

As an advantage further configurations and/or access security measures may be realized with the aid of the Web server in accordance with the invention. For instance, an email interface of the control means can be configured by way of the Web server. Dependent on the respective configuration the control means will for example transmit emails about the operational states of the valve cluster to an emails address able to be configured via the email interface. Furthermore conditions as to when an email is to be transmitted are able to be configured by way of such an email interface.

Preferably an access security measure is provided at the communication interface and/or the Web server, which is able to be secured, for example, by a password, by request or biometric data or the like.

The communication interface may be an individual interface for the monitoring means. It would be conceivable however for the communication interface to be designed also for receiving control instructions of a master control means for the control of the valve cluster. In this case it is an advantage for the communication interface to give preference to a communication of the master control means with the valve cluster over communication of the Web server with the monitoring means so that control instructions of the control means are treated with priority.

Moreover it would be conceivable for control instructions also to be transmitted by the monitoring means, for example by depressing a control element, displayed on graphic control or operating interface of the monitoring means, of the at least one monitoring page.

In the following one working example of the invention will be described with reference to the drawings.

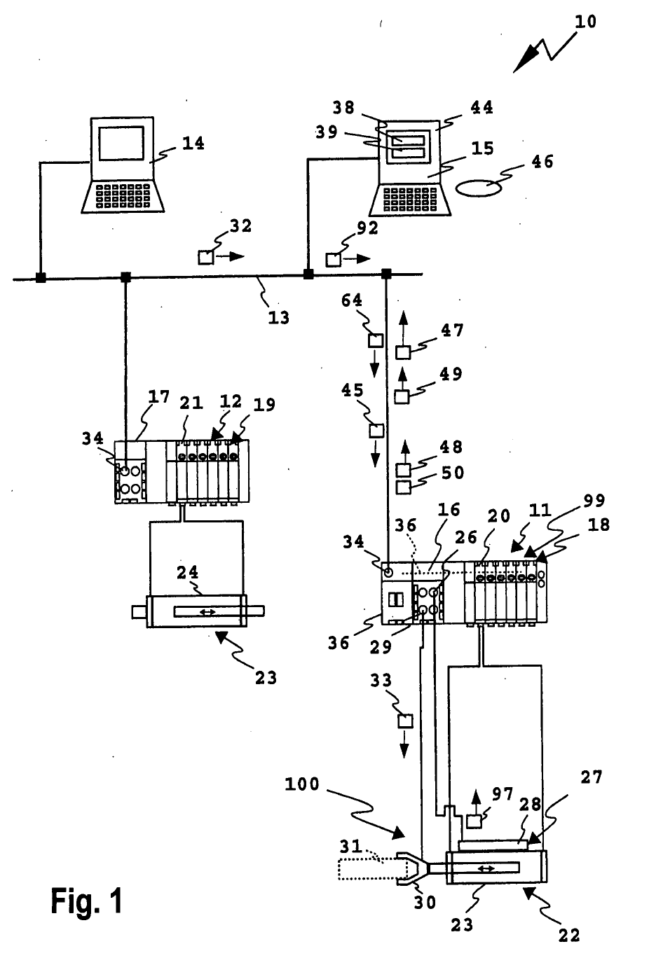

FIG. 1 shows an arrangement with valve clusters in accordance with the invention and a monitoring means.

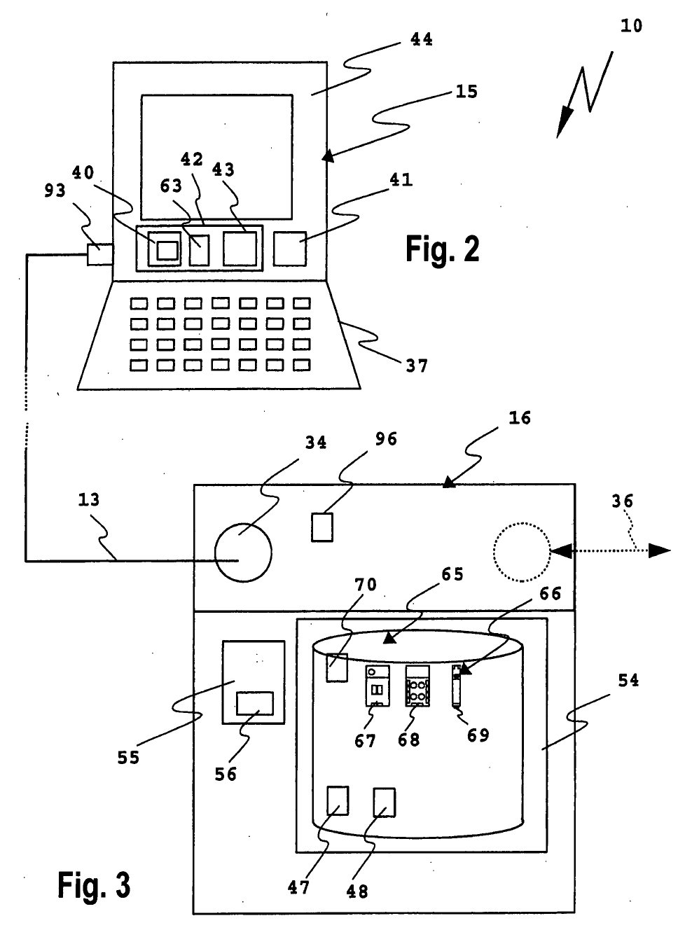

FIG. 2 diagrammatically shows the monitoring means of FIG. 1 in detail.

FIG. 3 is a diagrammatic showing of a control means of one of the valve clusters in accordance with FIG. 1 in detail.

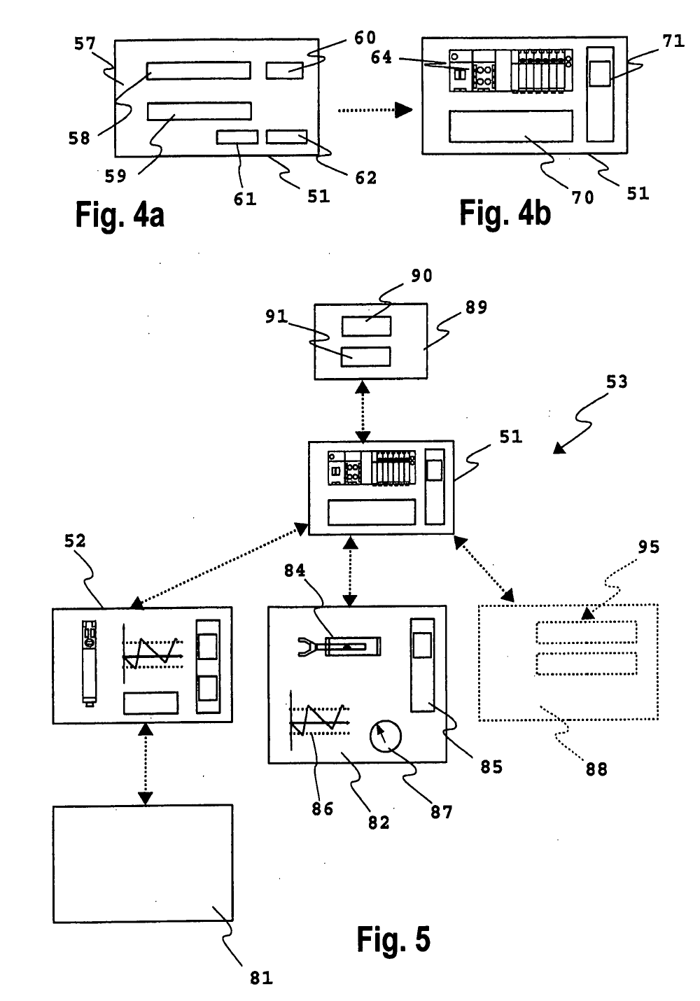

FIG. 4a shows the basic structure of a monitoring page.

FIG. 4b shows the monitoring page in accordance with FIG. 4a, which is supplemented with reload data.

FIG. 5 shows the tree structure of a dynamically produced Website of the valve cluster in accordance with FIG. 3.

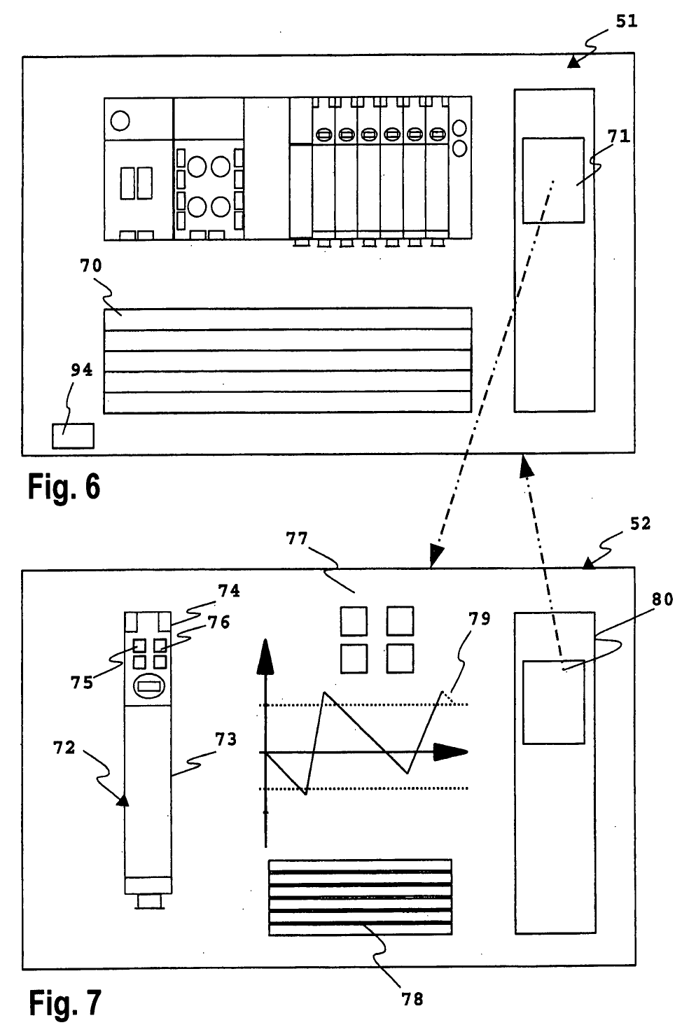

FIG. 6 is a diagrammatic detailed view of a first monitoring page of the Website in accordance with FIG. 5, which represents an overall view of the valve cluster.

FIG. 7 shows a second monitoring page of the Website according to FIG. 5, which represents a detailed view of a valve.

A first and a second pneumatic valve cluster 11 and 12 of a fluid power arrangement 10 are able to be controlled by way of a communication network 13, as for example a field bus or an ethernet and more particularly a industrial ethernet by a master control means 14 and able to be monitored by a monitoring means 15. The valve clusters 11 and 12 comprise decentral, local control means 16 and 17 which in the present case are similar so that in the following only the control means 16 will be described in detail.

The control means 16 and 17 get instructions 32 from the master control means 14 by way of the communication network 13 for the control of the connected components 99 and 100, for example for the control of pneumatic valve arrangements 18 and 19, which are connected in a line direction on the respective control means 16 and 17. Valves 20 and 21 of the pneumatic valve arrangements 18 and 19 serve for the purpose of fluid control and more particularly pneumatic control of external actuators 22 and 23, for example pneumatic cylinders 24 and 25, which are connected by way of pneumatic lines, not explicitly referenced, with the valves 20 and 21.

By way of an output interface 29, for example a digital and/or analog output interface, for external actuators it is possible for the control means 16 and 17 to issue control instructions, for example to an electrical gripper for gripping objects 31. The gripper 30 is arranged on the front end of the piston rod of the cylinder 24.

The control means 16 and 17 furthermore have input interfaces 26 for the input of messages from sensors 27, f. i. in the form of a displacement measuring system 28 on the pneumatic cylinder.

The input interfaces 26 and the output interfaces 29 can be designed in the form of bidirectional interface.

Thus the control means 16 and 17 may execute control instruction 32 of the master control means 14 and issue same to internal components 99, for example the valves 20 and 21 or external components 100, for example external actuators 22 and 23. Furthermore it is for the control means 16 and 17 to send messages to the master control means 14, for example messages 97 from the sensors 27 or the valves 18 and 19.

The control means 16 and 17 may with advantage, like other, control means in accordance with the invention, locally monitor and/or control the components 99 and 100, more especially in the manner of a memory programmable control. For instance the control means 16 may locally produce control instructions for a motion sequence of the cylinder 24 to the valve 20.

A particularly convenient form of monitoring and administration of the valve clusters 11 and 12 on the other hand is possible with the monitoring means 15, for example a personal computer, a notebook or the like. The monitoring means 15 is in the working example connected with the communication network 13 and communicates by way of same with communication interfaces 34 of the valve cluster 11 and 12. In the case of the valve cluster 11 a communication module 35 is present for providing the communication interface 34, such module communicating with the control means 15 via an internal bus 36. The control means 17 of the valve cluster 12 possesses an integrated communication interface 34.

The dynamic generation and/or updating in accordance with the invention of a monitoring Website for the valve cluster 12 will now be explained.

The operator of the monitoring means 15 enters an address 38 or 39 of the control means 16 and 17, for example using a keyboard 37 to create a communication path with the control means 16 and 17. The operator then for example enters the addresses in a browser 40 whose program code is executed by a processor 41 and is held in the memory 42 of the monitoring means 15.

However it is possible as well for a search program 43 to find the valve clusters connected with the communication network 13, in the working example the valve clusters 11 and 12 and to display their addresses 38 and 39 on a monitor 44 of the monitoring means 15 thereof. By a mouse click or similar action the operator will select the monitoring means 16 of the valve cluster 11 for example for the following communication.

In a first optional working step data 45 which are stored for instance on data medium (such as a CD) are loaded by the monitoring means 15 or some other communication means (not illustrated) in the control means 16. The data for example include a first and a second page data set 47 and 48 and first and second reload data 49 and 50 for building first and second monitoring pages 51 and 52 able to be represented by the browser 40, of a Website 53 for monitoring and/or diagnosing and/or servicing the valve cluster 11. The control means 16 stores the data 45 in a memory 54. It would be conceivable as well for the data 45 to be preconfigured prior to being stored in the memory 54.

After entry of the address 38 the browser 40 will for example produce a first message 92 for request of the page data set 47 or for request of an access page 89 for the control means 16.

A Web server 56 executed by a processor 55 makes available, in a manner dependent on the structure and status of the valve cluster 1 the page data sets 47 and 48, and the reload data 49 and 50 and further page data sets and reload data, something which will be described in the following. The actual dynamic structure and the dynamic updating of the monitoring pages however do not fully require the resources of the processor 55. A substantial processor power is advantageously provided by the processor 41 of the monitoring means 15.

The page data set 47 comprises a basic structure 57 in a markup language, as for example HTML, with void tables 58, 59 and 60 and request program code 61 and generation program code 62. The request program code 61 is for example a JAVA applet, which is able to be executed by a virtual machine 63 of the monitoring means 16. The generation program code 62 is for instance a JAVA script, which is executed by the browser 40.

On executing the request program code 61 the monitoring means 15 produces a message 64 for the request of reload data 49 from the Web server 56. From the stored data 45 the Web server 56 selects data modules 65 in a manner dependent of a structure and status of the valve cluster 11 and transmits same as reload data 49 to the monitoring means 15. By executing the generation program code 62 the browser fill the basic structure 57 of the monitoring page 51 with the data modules 65. It will be clear that the monitoring means 15 may transmit several messages 64 to the control means 15 and the same can transmit the reload data 49 in several answering messages to the monitoring means 15 in installments.

The data modules 65 will for example contain graphic representations 66 of the individual components of the valve cluster 11, for example representations 67, 68 and 69 of the communication module 35, of the control means 17 and of the valves 18.

Furthermore the data modules 65 for instance comprise a subtable 70 and navigation elements 71 which the browser 40 inserts in the tables 59 and 60 on execution of the generation program code 62. The subtable comprises conditions, as for instance operational conditions, error states or the like, of the components of the valve cluster 11 line by line in text form.

With the aid of the navigation element 71, as for example a button, it is possible to navigate on farther on the Website. By depressing the navigation element 71 the operator will arrive for instance at the monitoring page 52, which relates to the valve 20. The request program code 61 will then request the page data set 48 at the Web server 56. Details about the valve 20 are able to be displayed on the monitoring page 20. For instance the monitoring page 52 will show the valve 20 in the form of a larger graphic representation 72.

Preferably in the page data set 48 for generation of the monitoring page 52 request program code and generation program code are also included, such code being matched individually to the page 52 and differing from the request program code 61 and the generation program code 62.

The graphic representation 72 is generated by the browser 40 from graphic segments 73 for the individual representation of a bottom and a top part 75 of the valve 20. By executing the generation program code the browser 40 fits together the segments 73 and 73 to form the graphic representation 72 and an overall representation. On the top part 75 display elements 76, for example LEDs of the valve 20 are represented, which signalize an operational state optically, or, respectively, using a color display.

Dependent on the respective operational state of the valve 20 the graphic segment 74 changes, for example to representations in different colors, which represent further conditions of the display elements 76. The respective update is brought about by the request program code or the generation program code, that causes the monitoring means 15 to transmit an update request program message to the control means 16. The control means 16 then transmits reload data with graphics and/or text representations to the monitoring means 15, which represent the current operational state of the valve 20 for example.

Further elements are represented on the monitoring page 52, as for example an enlarged graphic representation 77 of the display elements 76, a table 78, which line by line indicates an operational condition or an error condition of the valve 20, and furthermore a graphic events table 79 for a predetermined time with respect to the valve 20 and furthermore navigation elements 80.

By pressing on one of the navigation elements 80 the operator will arrive for example back at the monitoring page 51 or at the adjacent pages 81 and 82.

On the page 82 the period of time for the events table 79 may be configured. Error conditions or the like, which are to be included in the events table 79, are able to be configured on the page 81.

The monitoring page 82 relates to the monitoring of the gripper 30 and of the pneumatic cylinder 24. The graphic representation 84 is preferably cyclically updated in order to represent an operational condition of the components 24 and 30 in real time, for example a motion cycle. Furthermore the page 82 includes navigation elements 85 and also an events table 86 for the operational timing, error status or the like of the actuators 24 and 30. It will be clear that other types of graphic representations are possible, as for example a representation 87 in the form of a manometer of a dial gage, a linear scale or the like. The Website 53 may comprise further pages 88, not illustrated. On the page 88 at entry spaces 95 parameters of an email interface of the valve cluster 11 may be configured.

Preferably an access to the Website 51 is secured by way of an access page, at which the operator can enter his username and a password in spaces 90 and 91.

The request program code 61 selectively opens an UDP or HTTP interface, the request program code 61 preferably switching over to the respectively suitable protocol at the interface 93 of the monitoring means 15 for the communication network.

As long as the communication between the monitoring means 15 and the control means 16 is intact an update display 94 will be indicated on the browser 40 by execution of, for example, the program codes 61 and 62. The updating display 94 is for example a graphic representation in green, when communication is functioning and in red when communication is down.

1. A valve cluster including fluid power valves arranged in a row direction against each other and a control means for the control and/or monitoring of at least one internal component comprised in the valve cluster or at least one external component connected with the valve cluster, the control means comprising a Web server for the provision of monitoring data relevant to the at least one component for a monitoring means at a communication interface, wherein the monitoring data, which are provided by the Web server to the monitoring means on request, comprise at least one page data set for a monitoring page able to be represented by a browser of the monitoring means in a markup language, and wherein the at least one page data set contains request code on whose execution by means of a processor the monitoring means transmits, for the generation of the monitoring page, at least one message for the request of reload data to the Web server, and wherein the control means is adapted to transmit the reload data on the basis of stored data modules in a manner dependent on a structure and/or a status of the valve cluster and/or the at least one component by way of the communication interface, and wherein the at least one page data set or the reload data comprise generation program code on whose execution by means of the processor the monitoring means dynamically generates and/or updates the monitoring page on the basis of the reload data.

2. The valve cluster as set forth in claim 1, wherein the at least one component comprises a valve in the valve cluster and/or at least one external actuator connected with an input and/or output interface and/or at least one sensor connected with an output and/or input interface.

3. The valve cluster as set forth in claim 1, wherein the at least one page data set constitutes a component of a Website for the at least partial representation of the valve cluster and/or of the at least one component, the monitoring means dynamically generating and/or updating the Website by the execution of the request program code and the generation program code interactively with the control means.

4. The valve cluster as set forth in claim 1, wherein the at least one page data set or the reload data comprise data for the generation of at least one navigation element indicated on the browser that on activation of the at least one navigation element the request program code or the generation program code transmits a message for requesting a second monitoring page to the Web server, and wherein the Website transfers a page data set with a second request program code able to be executed by the processor of the monitoring means and/or a second generation program code for requesting second reload data and for dynamic generation and/or updating the second monitoring page.

5. The valve cluster as set forth in claim 1, wherein the generation program code and/or the request program code is adapted for cyclical updating the monitoring page.

6. The valve cluster as set forth in claim 1, wherein the at least one page data set comprises at least one basic structure of the monitoring page which on execution of the generation program code is filled with contents on the basis of the reload data.

7. The valve cluster as set forth in claim 6, wherein the basic structure comprises at least one void table with at least one table line.

8. The valve cluster as set forth in claim 1, wherein data for the at least one page data set and/or the reload data are able to be loaded more particularly by way of the communication interface into the control means.

9. The valve cluster as set forth in claim 1, wherein the data modules include graphic representations of the at least one component comprised in the valve cluster or connected with the valve cluster.

10. The valve cluster as set forth in claim 9, wherein the Web server transmits the graphic representations as segments of an overall representation and generation program code is designed for combining the segments to constitute an overall representation.

11. The valve cluster as set forth in claim 9, wherein the graphic representations comprise a graphic events table of the respective operational or error status of the component for a predetermined or preset period of time.

12. The valve cluster as set forth in claim 9, wherein the generation program code and/or the request program code is designed to represent a graphic update display on the monitoring page.

13. The valve cluster as set forth in claim 1, wherein the request program code and/or the generation program code are constituted by separate program parts or by a single program.

14. The valve cluster as set forth in claim 1, wherein the request program code and/or the generation program code comprise at least one JAVA applet and/or JAVA script.

15. The valve cluster as set forth in claim 1, wherein the request program code makes available a UDP interface and/or an HTTP interface.

16. The valve cluster as set forth in claim 1, wherein by way of the Web server an email interface of the control means is able to be configured.

17. The valve cluster as set forth in claim 1, wherein the communication interface and/or the Web server is able to be secured for access security using a password.

18. The valve cluster as set forth in claim 1, wherein the communication interface is designed for receiving control instructions of a master control means.

19. The valve cluster as set forth in claim 1, wherein the communication interface comprises a bus interface and more especially a field bus interface and/or an ethernet interface.

20. A communication method for a valve cluster having valves lined up in a row direction against each other and a control means for controlling and/or monitoring at least one internal component comprised in the valve cluster or an external component connected with the valve cluster, the control means possessing a Web server for monitoring data with respect to the at least one component for a monitoring means at a communication interface, the method comprising the steps of:
requesting monitoring data by the monitoring means at the Web server,
transferring at least one page data set for a monitoring page able to be represented by a browser of the monitoring means in a markup language from the Web server to the monitoring means,
execution of request program code contained in at least one page data set by a processor of the monitoring means,
transmission of at least one message for retrieval of reload data at the Web server by execution of the request program code,
transmission of the reload data from the Web server to the monitoring means on the basis of stored data modules in a manner dependent on a structure and/or a status of the valve cluster and/or of the at least one component by way of the communication interface,
execution of generation program code included in the at least one page data set or in the reload data by the processor of the monitoring means and concurrently
dynamic generation and/or updating of the monitoring page on the basis of the reload data.
